(19) United States
(12) Patent Application Publication
(10) Pub. No.: US 2026/0141143 A1
(43) Pub. Date: May 21, 2026

(54) STATIC ANALYSIS FOR BUFFER INSERTION IN A NETWORK-ON-CHIP TOPOLOGY

(71) Applicant: ARTERIS, INC., Campbell, CA (US)

(72) Inventors: Amir CHARIF, Paris (FR); Ya-rou Hsu, Paris (FR)

(73) Assignee: ARTERIS, INC., Campbell, CA (US)

(21) Appl. No.: 19/392,065

(22) Filed: Nov. 17, 2025

Related U.S. Application Data
(60) Provisional application No. 63/721,425, filed on Nov. 15, 2024.

(51) Int. Cl. G06F 30/327; G06F 115/02

(52) U.S. Cl. CPC G06F 30/327; G06F 2115/02

(57) ABSTRACT

A computer-implemented method for designing a network-on-chip (NoC) includes accessing a NoC topology of an electronic system including initiators and targets. The NoC topology includes a plurality of NoC elements and channels that connect the initiators to the targets. The method further includes playing multiple scenarios, wherein each of the scenarios includes parallel source-to-destination transmissions of packets in the NoC topology; for each of the scenarios, detecting transmission issues along at least one of the channels that is shared; and performing buffer insertion in the NoC topology to address the transmission issues. The transmission issues involve clock rates of sources, destinations and the channels in the NoC topology.

### CROSS REFERENCE TO RELATED APPLICATION

This application claims the benefit under 35 U.S.C. 119(e) of US Provisional Application Serial No. 63/721,425 filed on November 15, 2024 and titled SYSTEM AND METHOD FOR NETWORK ON CHIP (NOC) USING AUTOMATION DESIGN TOOL by Amir Charif et al., the entire disclosure of which is incorporated herein by reference.

### FIELD

The present technology is in the field of electronic computer-aided design of electronic systems and, more specifically, related to topology generation for a network-on-chip (NoC).

### BACKGROUND

A system on chip (SoC) may include initiators, targets, and a NoC for handling communications between the initiators and the targets. A NoC is superior to point-to-point connectivity by way of a more scalable communication architecture that makes use of packet transmissions. It can support an ever-increasing number of cores on a single chip and a demand for ever-increasing processing power related to artificial intelligence (AI) and other applications.

During design of a NoC for an SoC or other electronic system, an initial NoC topology may be generated quickly by automated topology synthesis. The initial NoC topology provides a good starting point for NoC design.

Later during NoC design, a dynamic simulation may be run to refine the NoC topology. The dynamic simulation may identify or reveal issues such as wait cycles, excess backpressure, and contention in the NoC topology. Buffers may be inserted in the NoC topology to address these issues.

### SUMMARY

In accordance with various embodiments and aspects herein, a computer-implemented method for designing a network-on-chip (NoC) includes accessing a NoC topology of an electronic system including initiators and targets. The NoC topology includes a plurality of NoC elements and channels that connect the initiators to the targets. The method further includes exploring or playing multiple scenarios, wherein each of the scenarios includes parallel source-to-destination transmissions of packets in the NoC topology; for each of the scenarios, detecting transmission issues along at least one of the channels that is shared; and performing buffer insertion in the NoC topology to address the transmission issues. The transmission issues involve clock rates of sources, destinations and the channels in the NoC topology.

In accordance with various embodiments and aspects herein, a product includes non-transitory computer-readable medium storing a network-on-chip (NoC) design tool. The NoC design tool, when executed, performs a method that includes accessing a NoC topology of an electronic system including initiators and targets. The NoC topology includes a plurality of NoC elements and channels that connect the initiators to the targets. The method further includes playing multiple scenarios, wherein each of the scenarios includes parallel source-to-destination transmissions of packets in the NoC topology. The method further includes, for each of the scenarios, detecting transmission issues along at least one of the channels that is shared; and performing buffer insertion in the NoC topology to address the transmission issues. The transmission issues involve clock rates of sources, destinations and the channels in the NoC topology.

In accordance with various embodiments and aspects herein, a computing system includes a processing unit, and computer-readable memory encoded with a network-on-chip (NoC) design tool. The NoC design tool, when executed, causes the processing unit to access a NoC topology of an electronic system including initiators and targets. The NoC topology includes a plurality of NoC elements and channels that connect the initiators to the targets. The NoC design tool, when executed, further causes the processing unit to play multiple scenarios including parallel source-to-destination transmissions of packets in the NoC topology; for each of the scenarios, detect transmission issues along at least one of the channels that is shared; and perform buffer insertion in the NoC topology to address the transmission issues. The transmission issues involve clock rates of sources, destinations and the channels in the NoC topology.

### BRIEF DESCRIPTION OF THE DRAWINGS

In order to understand the invention more fully, a reference is made to the accompanying drawings. The invention is described in accordance with the aspects and embodiments in the following description with reference to the drawings or figures(FIG.), in which like numbers represent the same or similar elements. Understanding that these drawings are not to be considered limitations in the scope of the invention, the presently described aspects and embodiments and the presently understood best mode of the invention are described with additional detail through the use of the accompanying drawings.

FIG. 1 shows an example of an electronic system including a NoC.

FIG. 2 shows a method of generating a hardware description of a NoC in accordance with various aspects and embodiments herein.

FIG. 3 shows a method of generating a NoC topology in accordance with various aspects and embodiments herein.

FIG. 4 shows a graph of a NoC topology.

FIG. 5 shows the graph and a first playback scenario in a static simulation in accordance with various aspects and embodiments herein.

FIG. 6 shows the graph and a second playback scenario in a static simulation in accordance with various aspects and embodiments herein.

FIG. 7 shows the graph and a third playback scenario in a static simulation in accordance with various aspects and embodiments herein.

FIG. 8 shows the graph after buffer insertion in accordance with various aspects and embodiments herein.

FIG. 9 shows a computing system including computer-readable memory that stores a NoC design tool in accordance with various aspects and embodiments herein.

### DETAILED DESCRIPTION

The following describes various examples of the present technology. Generally, examples can use the described aspects in any combination. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one embodiment,” “an embodiment,” “certain embodiment,” “various embodiments,” or similar language means that a particular aspect, feature, structure, or characteristic described in connection with the embodiment is included in at least one embodiment.

Thus, appearances of the phrases “in one embodiment,” “in at least one embodiment,” “in an embodiment,” "in certain embodiments," and similar language throughout this specification may, but do not necessarily, all refer to the same embodiment or similar embodiments. Furthermore, aspects and embodiments described herein are merely exemplary, and should not be construed as limiting of the scope or spirit of the invention as appreciated by those of ordinary skill in the art. All statements herein reciting principles, aspects, and embodiments are intended to encompass both structural and functional equivalents thereof. It is intended that such equivalents include both currently known equivalents and equivalents developed in the future. Furthermore, to the extent that the terms "including", "includes”, “having", "has", "with", or variants thereof are used in either the detailed description and the claims, such terms are intended to be inclusive in a similar manner to the term "comprising."

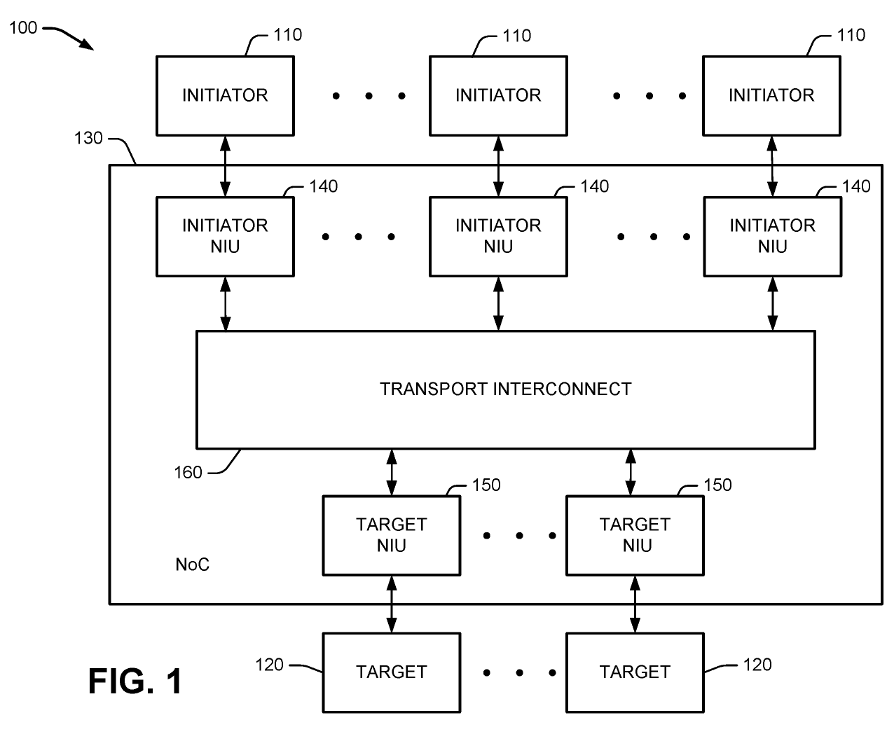

Reference is made to FIG. 1, which illustrates a simple example of an SoC 100 including a plurality of initiators 110 and targets 120. Examples of the initiators 110 include central processing units (CPUs), graphics processing units (GPUs), video cards, accelerators, and direct memory access (DMA) controllers. Examples of the targets 120 include volatile memory, persistent memory, and peripherals.

The SoC 100 further includes a NoC 130. The NoC 130 sends request transactions from an initiator 110 to one or more targets 120. For example, the NoC 130 receives a request transaction from an initiator 110, decodes an address in the request transaction, and transports the request transaction to the target 120, which handles the request transaction. The target 120 may respond with a response transaction, which is transported back to the initiator 110 via the NoC 130.

The NoC 130 includes a plurality of network interface units (NIUs) 140 and 150 and a transport interconnect 160. Each initiator 110 is coupled to the transport interconnect 160 via a corresponding initiator NIU 140. Each target 120 is coupled to the transport interconnect 160 via a corresponding target NIU 150.

Each initiator NIU 140 is configured to convert the protocol used by its corresponding initiator 110 into a transport protocol that is used inside the NoC 130. Each target NIU 150 is configured to convert the transport protocol used inside the NoC 130 into a protocol that is used by its corresponding target 120. The transport protocol is typically based on the transmission of packets.

The transport interconnect 160 transports packets between the initiator NIUs 140 and the target NIUs 150. The transport interconnect 160 includes switches, adapters, and buffers. Switches may be used to route flows of traffic between sources and destinations. Adapters may be used to deal with various conversions between data width, clock domains, and power domains. Buffers may be used to insert pipelining elements to span long distances, or to store packets to deal with rate adaptation between fast senders and slow receivers or vice-versa.

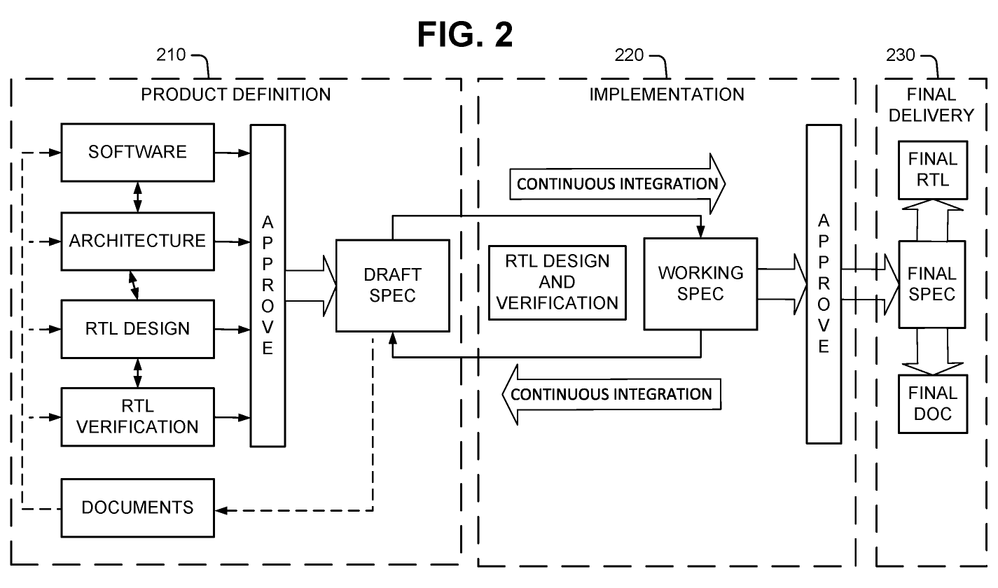

FIG. 2 shows a method of generating a hardware description of a NoC. At block 210, a product is defined. An SoC architect designs a specification that includes a floorplan for an SoC, power strategy, and constraints related to the SoC’s environment (e.g., clocks and their frequencies, quality of service, and type of protocol used with macros). The specification also describes a communication policy, which may include a connectivity table that specifies NoC connectivity for different traffic classes.

Among other things, the floorplan defines areas on the chip for major functional blocks of the chip, including initiators and targets. The floorplan also defines blockages, and it also defines the area that will be used for a NoC (that is, “free space” for the NoC). The specification may place additional constraints on the NoC. Examples of additional constraints include frequency, routing congestion, and power consumption.

An initial NoC topology is generated to fit within the free space defined by the floorplan. After the initial NoC topology has been generated, automated buffer detection and insertion is performed according to a method herein. The automated method can be performed quickly and inexpensively (relative to a dynamic simulation), and identifies and addresses issues such as wasted wait cycles, excess backpressure, and contention before running a dynamic simulation. Buffer insertion can be performed without intervention by a NoC designer. The automation performed by the design tool using artificial intelligence (AI) module that is trained and uses large language models (LLM) or machine learning models (MLM) for performing the identification and correction of the issues noted herein. As various scenarios are explored, outlined below, the AI can receive input as feedback to further improve the LLM and/or the MLM.

A hardware description of the NoC design is generated. Register Transfer Level (RTL) may be used for design and verification flow. In addition, software is developed. An RTL description may then be delivered to an SoC integrator in the form of a draft specification.

At block 220, a product definition is implemented. The SoC integrator performs integration, synthesis, and simulations to determine whether the NoC design in the RTL description fits into the free space defined by the floorplan, exhibits predictable results about operation frequency, and satisfies other constraints such as routing congestion, and power consumption. The integration is continuous until a working specification has been approved.

At block 230, a final specification is delivered. The final specification may include a final RTL description and documentation.

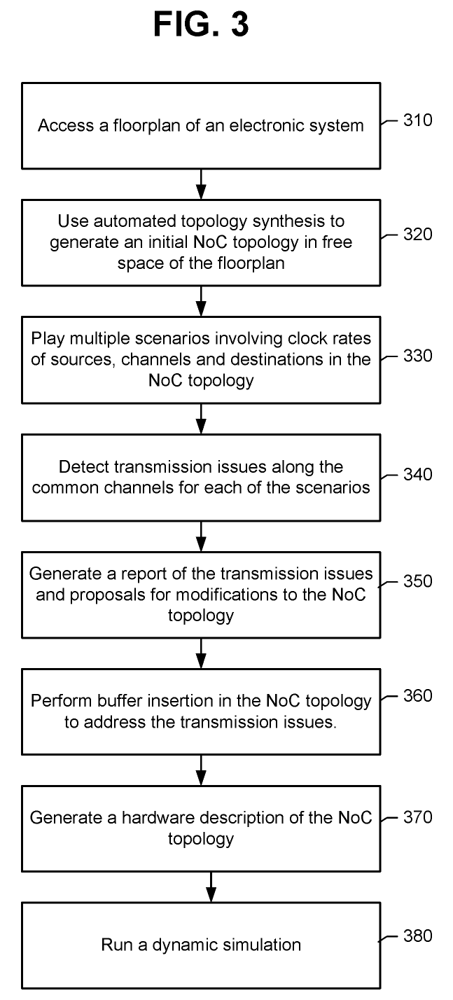

Reference is made to FIG. 3, which shows a computer-implemented method of generating a NoC topology for an electronic system that includes a plurality of initiators and targets. At block 310, a floorplan of the electronic system is accessed. The floorplan shows major functional blocks including the initiators and the targets. The floorplan also shows free space for placing a NoC. The floorplan also shows positions of initiator ports and target ports.

At block 320, automated topology synthesis is used to generate an initial NoC topology in the free space. Initiator NIUs are located at the initiator ports, and target NIUs are located at the target ports. The initial topology includes switches and channels that connect the initiator NIUs to the target NIUs in accordance with a communication policy.

An example of automated topology synthesis is disclosed in Applicant/Assignee’s U.S. Serial No. 19/095,082 filed 31 March 2025 and titled “INCREMENTAL TOPOLOGY SYNTHESIS FOR A NETWORK-ON-CHIP,” the entire disclosure of which is incorporated herein by reference. In general, a source is selected, and multiple destinations to which the source will be connected are identified. New connections are incrementally added to the NoC topology, one connection at a time. Adding a new connection includes selecting a next destination, and adding to the topology a new valid shortest distance connection from the next destination to an existing connection in the topology.

After the switches have been added, sufficient bandwidth in the initial NoC topology is allocated. For example, serialization and clocks are configured, and new channels are created.

In some embodiments, an existing NoC topology may be loaded from memory instead of performing blocks 310 and 320. Thus, a NoC topology may accessed by synthesizing an initial NoC topology, or by loading an existing NoC topology.

Automated buffer detection and insertion is then performed on the NoC topology. At block 330, multiple scenarios involving sources, channels and destinations in the NoC topology are played. The sources may be initiators, and the destinations may be targets. However, the sources and destination may also be switches and other NoC elements.

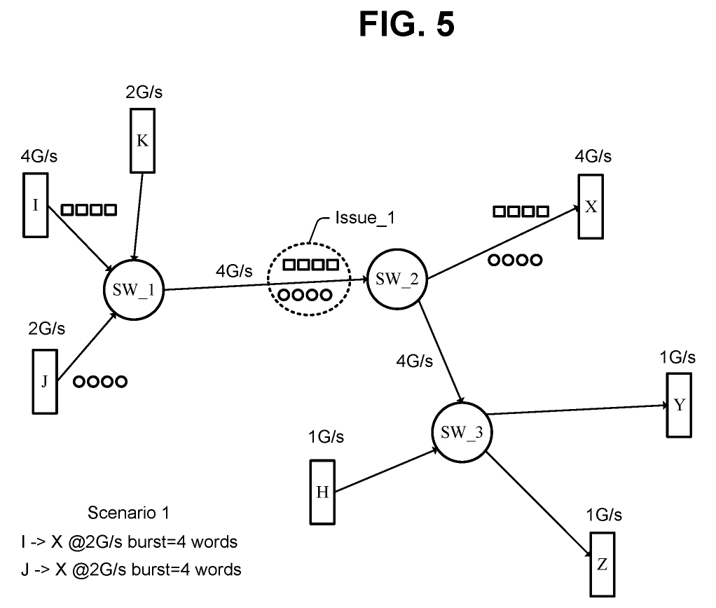

Each scenario includes parallel source-to-destination transmission of a packet along at least one shared channel. Examples of these scenarios are illustrated in FIGS. 5, 6 and 7.

At block 340, transmission issues along the shared channels are detected for each of the scenarios. The issues include wait cycles, excess backpressure, and contention. The detection includes examining clock rates and channel capacity, and identifying the issues from those numbers.

At block 350, a report of the transmission issues and proposals for modifications to the NoC topology may be generated prior to the buffer insertion. The report enables a NoC designer to analyze and manually correct any reported transmission issues. performance issues.

At block 360, buffer insertion in the NoC topology is performed to address the transmission issues. For instance, rate adapters may be instantiated and added to the NoC topology to address wasted cycles. First-in, first out buffers (FIFOs) may be instantiated and added to the NoC topology to address excess backpressure. FIFOs may be instantiated and inserted, and switches in the NoC topology may be modified to address contention. Buffer configurations and locations in the NoC topology are estimates. The buffers may be instantiated with configurations such as storage capacity, clock, and data width.

In some embodiments, the buffer insertion may include proposing a topology modification in response to each scenario, generating a composite of proposed topology modifications for all of the scenarios, and modifying the NoC topology per the composite. The composite can identify and eliminate duplicative and otherwise unnecessary buffers.

In some embodiments, different combinations of buffers can be simulated to find the best combination of buffers that solves all of the transmission issues and minimize relevant cost metrics such area and wire length. In these embodiments, the static analysis may be used as an evaluation function for a larger solver (e.g. genetic algorithm, Monte Carlo, etc.).

The method of FIG. 1 performs a quick static analysis that allows buffers to be added to the NoC topology without running an expensive dynamic simulation.

At block 370, a hardware description of the NoC topology is generated. For example, an RTL description may be generated.

At block 380, a dynamic simulation is performed. The dynamic simulation enables the buffers inserted at block 360 to be optimized. For instance, buffer types, sizes, locations in the NoC topology may be optimized.

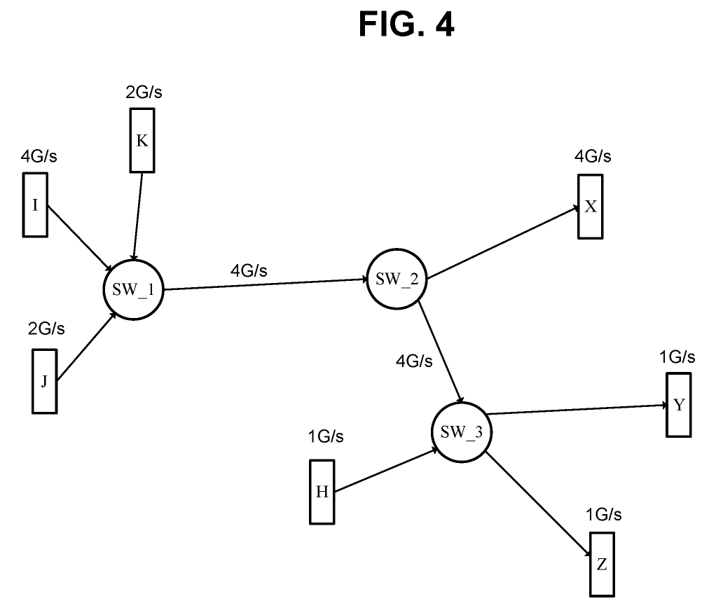

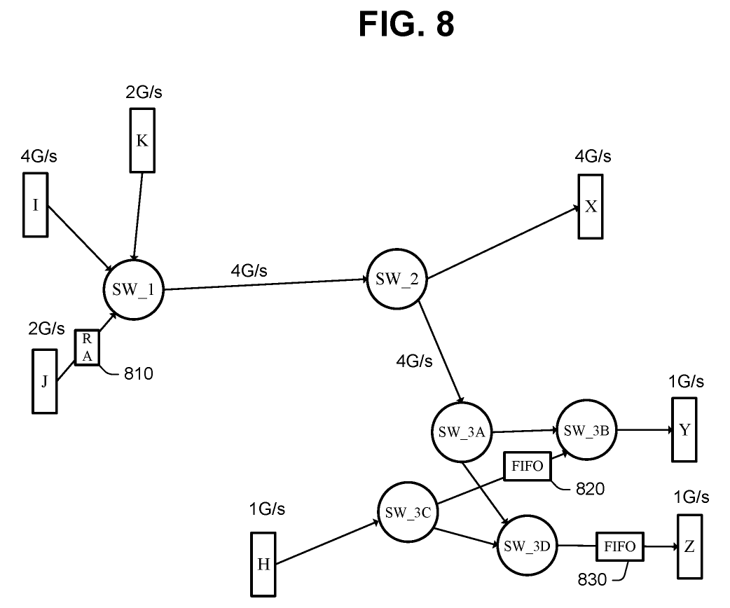

The method of FIG. 3 will now be applied to a simple example of a NoC topology 400 shown in FIG. 4, FIGS. 5, 6 and 7 show the NoC topology 400 after different playback scenarios. FIG. 8 shows the NoC topology 800 after buffer insertion.

Reference is now made to FIG. 4. The NoC topology 400 includes sources I, J and K, destinations X, Yand Z, and switches SW_1, SW_2 and SW_3, and channels connecting the sources I, J and K to the destinations X, Y and Z. A channel has properties including a source/destination pair (e.g. CPU0/DDR1) and speed of the communication (e.g. 10 GB/s). Another property is average/peak burst (size of a single packet, e.g. 128 bits).

In the topology graph 400 of FIG. 4, transmission rate of source I is 2G/s. Transmission rate of sources J and K are 2G/s. Transmission capacity of a first channel CH_1 between switches SW_1 and SW_2 is 4G/s. Transmission capacity of a second channel CH_2 between switches SW_2 and SW_3 is also 4G/s.

Three scenarios will be played for the initial NoC. In scenario 1, source I sends a packet to destination X at 2G/s in a burst of four words, and, in parallel, source J sends a packet to destination X at 2G/s in a burst of four words. In scenario 2, source I sends a packet to destination X at 1G/s in a burst of four words, and, in parallel, source I sends a packet to destination Z at 1G/s in a burst of four words. In scenario 3, source J sends a packet to destination Y at 1G/s in a burst of four words, and, in parallel, source H sends a packet to destinations Y and Z at 1G/s in a burst of four words.

In this example, each packet includes 4 words or flits. When a source sends a packet, it sends the packet in multiple flits.

In some embodiments, the transmission issues can be detected by generating graphs of the NoC topology and annotating the graph with the scenarios during playback. Annotated graphs of the NoC topology are shown in FIGS. 5-7.

FIG. 5 shows the topology graph 400 of the NoC topology after playback of scenario 1. The packet in the first transmission (I->X) is sent at 4G/s and is represented by rectangles. The packet in the second transmission (sent at 2 G/s are represented by circles. A “first channel” refers to the channel between switches SW_1 and SW_2. The packet from source I enters the first channel at a rate of 4 G/s, and the packet from source J enters the first channel at a rate of 2 G/s. Capacity of the first channel is 4G/s. The rate of the packet from source J is lower than the capacity of the first channel. Since the packet is sent flit by flit, there are gap cycles between the flits.

The lower rate packet (from source J) can keep the higher rate packet (from source I) waiting. This issue can be addressed by inserting a rate adapter between source J and the first switch SW_1.

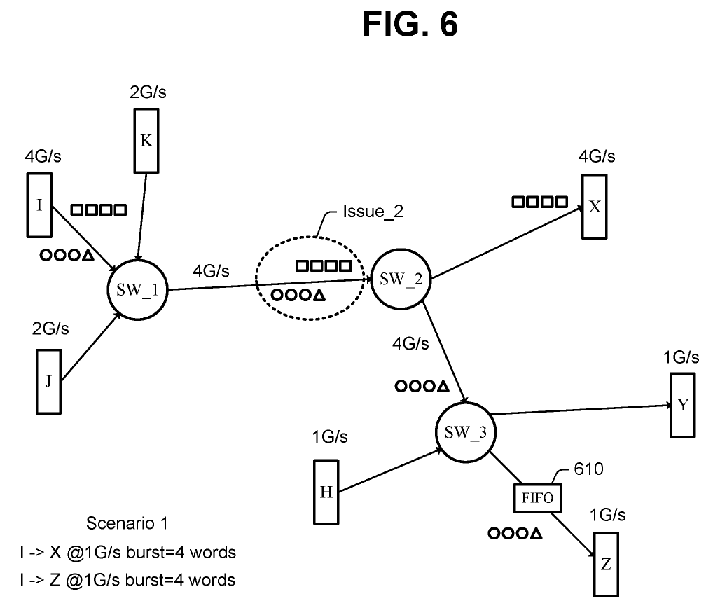

FIG. 6 shows the NoC topology after playback of scenario 2. The packet from source I and destined for destination X enters the first channel at a rate of 1 G/s, and the packet from source I and destined for destination Z enters the first channel at a rate of 1 G/s. A packet might exit the first channel at a rate lower than possible in the transmission I->X because destination Z is slow and does not consume packet flits fast enough.

The packet in transmission I-> Z may block flits going from I->X. This issue can be addressed by inserting a first-in, first out buffer upstream of destination Z.

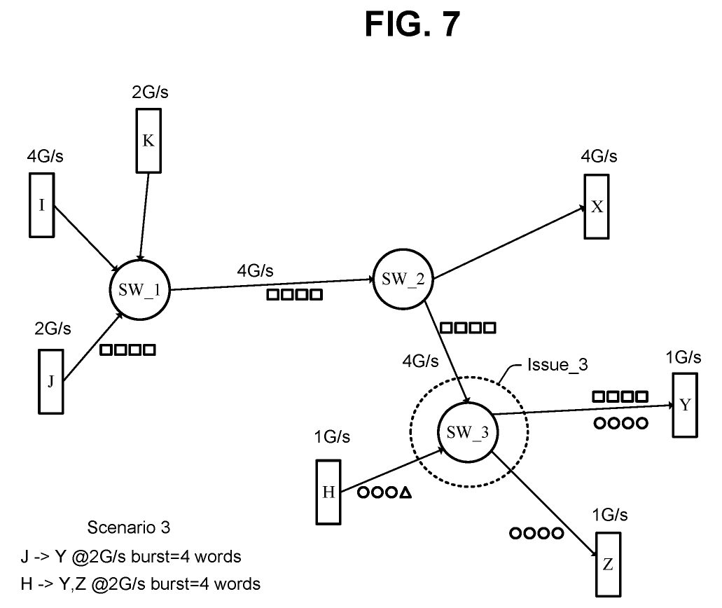

FIG. 7 shows the NoC topology after playback of scenario 3. The packet from source J is sent at 1 G/s. At the same time, a packet from source H is sent to destinations Y and Z via the third switch SW_3. The packet from source H to destination Z may be blocked if the previous transmission from source H to destination Y had to wait for the packet from source J. A blocked flit is represented by a triangle in FIG. 7.

As a result, contention occurs. This issue can be addressed by breaking up the third switch SW_3 to create separate paths from source H to destinations Y and Z. A first-in, first-out buffer in buffer is inserted in the path from source H to destination Y.

FIG. 8 shows a NoC topology graph 800 after buffers and switches have been inserted into the topology graph 400 of FIG. 7. A rate adapter 810 is inserted between source J and switch SW_1 to address the wait cycles issue.

As for the contention issue, switch SW_3 is been broken up into multiple switches: SW_3A, SW_3B, SW_3C and SW_3D. Whereas source H and switch SW_2 previously provided inputs to the third switch SW_3, and destinations Y and Z were previously outputs, each of these inputs and outputs now has its own switch. Thus, the output of SW_2 is now an input to switch SW_3A, and source H is an input to switch SW_3C. Destination Y is now an output of switch SW_3B, and destination Z is now an output of switch SW_3D. In addition, a FIFO 820 is inserted along the path between source H and destination Y.

As for the backpressure issue, a FIFO 830 is still inserted immediately upstream of destination Z. However, the FIFO 830 is now between switch SW_3D and destination Z.

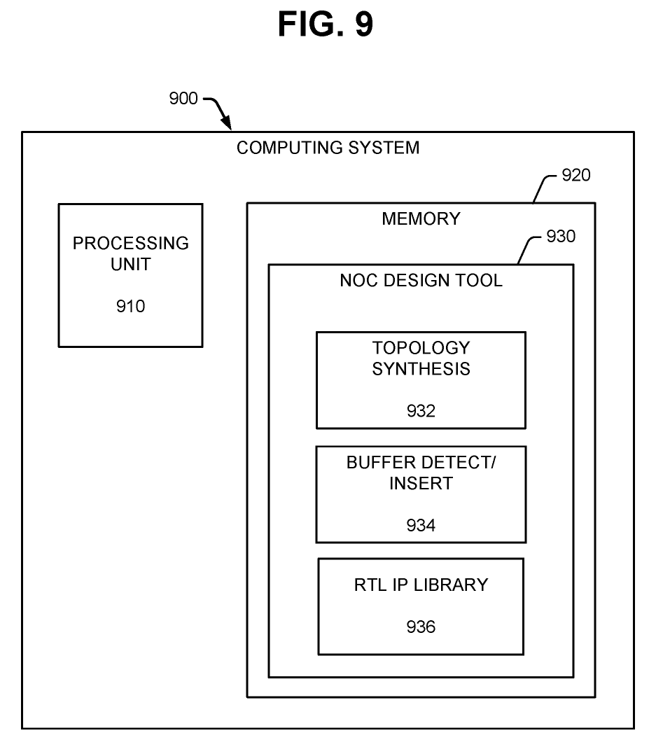

Reference is now made to FIG. 9, which illustrates a computing system 900 including a processing unit 910, and machine-readable memory 920 that stores a NoC design tool 930. The NoC design tool 930 includes an automated topology synthesis algorithm 932, and a buffer detection/insertion algorithm 934. The NoC design tool 930 may also include an RTL IP library 936. The RTL IP library 936 contains a collection of reusable IP cores designed for Register Transfer Language design that are used to create an RTL description of a NoC design.

Certain methods, which can be implemented in a product, according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code comprising instructions according to various example.

Some examples are one or more non-transitory computer readable media arranged to store such instructions for methods described herein. Whatever machine holds non-transitory computer readable media comprising any of the necessary code may implement an example. Some examples may be implemented as: physical devices such as semiconductor chips; hardware description language representations of the logical or functional behavior of such devices; and one or more non-transitory computer readable media arranged to store such hardware description language representations.

Certain examples have been described herein and it will be noted that different combinations of different components from different examples may be possible. Salient features are presented to better explain examples; however, it is clear that certain features may be added, modified and/or omitted without modifying the functional aspects of these examples as described.

Various examples are methods that use the behavior of either or a combination of machines. Method examples are complete wherever in the world most constituent steps occur. For example, IP elements or units include: processors (e.g., CPUs or GPUs), random-access memory (RAM – e.g., off-chip dynamic RAM or DRAM), a network interface for wired or wireless connections such as ethernet, WiFi, 3G, 4G long-term evolution (LTE), 5G, and other wireless interface standard radios. The IP may also include various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices processors perform steps of methods as described herein.

Descriptions herein reciting principles, aspects, and embodiments encompass both structural and functional equivalents thereof. Elements described herein as coupled have an effectual relationship realizable by a direct connection or indirectly with one or more other intervening elements.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-filed protocols, or RFID.

To the extent that the terms "including", "includes”, “having", "has", "with", or variants thereof are used in either the detailed description and the claims, such terms are intended to be inclusive in a similar manner to the term "comprising."

The scope of the invention, therefore, is not intended to be limited to the exemplary embodiments shown and described herein. Rather, the scope and spirit of present invention is embodied by the appended claims.

What is claimed is:

1. A computer-implemented method of designing a network-on-chip (NoC), the method comprising:
accessing a NoC topology for an electronic system that includes initiators and targets, wherein the NoC topology includes a plurality of NoC elements and channels that connect the initiators to the targets;
exploring multiple scenarios, wherein each of the scenarios includes parallel source-to-destination transmissions of packets in the NoC topology;
for each of the scenarios, detecting transmission issues along at least one of the channels that is shared, wherein the transmission issues involve at least clock rates of sources, destinations and the channels in the NoC topology; and
performing buffer insertion in the NoC topology to address the transmission issues.

2. The method of claim 1, wherein the accessing includes generating an initial NoC topology using incremental topology synthesis.

3. The method of claim 1, wherein detecting the transmission issues includes:
generating a graph of the NoC topology; and
annotating the graph for each of the scenarios during playback.

4. The method of claim 1, wherein performing the buffer insertion includes:
proposing topology modifications in response to the transmission issues;
generating a composite of proposed topology modifications; and
modifying the NoC topology per the composite.

5. The method of claim 4, wherein performing the buffer insertion further includes generating a report including the transmission issues and also the proposed topology modifications prior to modifying the NoC topology.

6. The method of claim 1, further comprising:
generating a hardware description of the NoC topology after the buffer insertion; and
performing a dynamic simulation on the hardware description to optimize buffers that were inserted into the NoC topology.

7. The method of claim 1, wherein at least one of the scenarios is configured to reveal buffer-related issues involving wasted cycles by determining whether a packet enters a shared channel at a lower rate than the shared channel’s capacity; and wherein performing the buffer insertion includes inserting a rate adapter upstream of one of the sources associated with the lower rate.

8. The method of claim 1, wherein at least one of the scenarios is configured to reveal buffer-related issues involving excess backpressure by determining whether a packet exits a shared channel at a lower rate than the shared channel’s capacity; and wherein the buffer insertion includes inserting a first-in, first-out buffer upstream of one of the destinations associated with the lower rate.

9. The method of claim 1, wherein at least one of the scenarios is configured to reveal buffer-related issues involving whether a packet, after entering a shared channel, has to wait for a previous transmission to compete at a given destination; and wherein a first-in, first-out buffer is inserted between the given destination and a given switch immediately upstream of the given destination.

10. A product comprising non-transitory computer-readable medium storing a network-on-chip (NoC) design tool that, when executed, performs a method including:
accessing a NoC topology of an electronic system including initiators and targets, wherein the NoC topology includes a plurality of NoC elements and channels that connect the initiators to the targets;
playing multiple scenarios, wherein each of the scenarios includes parallel source-to-destination transmissions of packets in the NoC topology;
for each of the scenarios, detecting transmission issues along at least one of the channels that is shared, wherein the transmission issues involve clock rates of sources, destinations and the channels in the NoC topology; and
performing buffer insertion in the NoC topology to address the transmission issues.

11. The product of claim 10, wherein accessing the NoC topology includes generating an initial NoC topology using incremental topology synthesis.

12. The product of claim 10, wherein at least one of the scenarios is configured to reveal buffer-related issues involving wasted cycles by determining whether a packet enters a shared channel at a lower rate than the shared channel’s capacity; and wherein performing the buffer insertion includes inserting a rate adapter upstream of one of the sources associated with the lower rate.

13. The product of claim 10, wherein at least one of the scenarios is configured to reveal buffer-related issues involving excess backpressure by determining whether a packet exits a shared channel at a lower rate than the shared channel’s capacity; and wherein the buffer insertion includes inserting a first-in, first-out buffer upstream of one of the destinations associated with the lower rate.

14. The product of claim 10, wherein at least one of the scenarios is configured to reveal buffer-related issues involving whether a packet, after entering a shared channel, has to wait for a previous transmission to compete at a given destination; and wherein a first-in, first-out buffer is inserted between the given destination and given switch immediately upstream of the given destination.

15. The product of claim 10, wherein the method further includes:
generating a hardware description of the NoC topology after the buffer insertion; and
performing a dynamic simulation on the hardware description to optimize buffers that were inserted into the NoC topology.

16. A computing system comprising a processing unit; and computer-readable memory encoded with a network-on-chip (NoC) design tool that, when executed, causes the processing unit to:
access a NoC topology of an electronic system including initiators and targets, wherein the NoC topology includes a plurality of NoC elements and channels that connect the initiators to the targets;
play multiple scenarios including parallel source-to-destination transmissions of packets in the NoC topology;
for each of the scenarios, detect transmission issues along at least one of the channels that is shared, wherein the transmission issues involve clock rates of sources, destinations and the channels in the NoC topology; and
perform buffer insertion in the NoC topology to address the transmission issues.

17. The system of claim 16, wherein at least one of the scenarios is configured to reveal buffer-related issues involving wasted cycles by determining whether a packet enters a shared channel at a lower rate than the shared channel’s capacity; and wherein performing the buffer insertion includes inserting a rate adapter upstream of one of the sources associated with the lower rate.

18. The system of claim 16, wherein at least one of the scenarios is configured to reveal buffer-related issues involving excess backpressure by determining whether a packet exits a shared channel at a lower rate than the shared channel’s capacity; and wherein the buffer insertion includes inserting a first-in, first-out buffer upstream of one of the destinations associated with the lower rate.

19. The system of claim 16, wherein at least one of the scenarios is configured to reveal buffer-related issues involving whether a packet, after entering a shared channel, has to wait for a previous transmission to compete at a given destination; and wherein a first-in, first-out buffer is inserted between the given destination and given switch immediately upstream of the given destination.

20. The system of claim 16, wherein the NoC design tool, when executed, further causes the processing unit to:
generate a hardware description of the NoC topology after the buffer insertion; and
perform a dynamic simulation on the hardware description to optimize buffers that were inserted into the NoC topology.
